(19) United States
(12) Patent Application Publication
(10) Pub. No.: US 2007/0239408 A1
(43) Pub. Date: Oct. 11, 2007

(54) THREAT MATRIX ANALYSIS SYSTEM

(76) Inventors: JoAnn T. Manges, Oak Ridge, TN (US); Alan Proctor, Knoxville, TN (US)

Correspondence Address: LUEDEKA, NEELY & GRAHAM, P.C., P O BOX 1871, KNOXVILLE, TN, 37901, US

(21) Appl. No.: 11/682,026

(22) Filed: Mar. 5, 2007

Related U.S. Application Data
(60) Provisional application No. 60/779,742, filed on Mar. 7, 2006.

(51) Int. Cl. G06F 17/10; G06F 15/00; G06F 7/60

(52) U.S. Cl. 703/2; 708/200

(57) ABSTRACT

A computerized system for evaluating a physical phenomenon. In some embodiments a data file defines at least one mathematical expression, and when multiple mathematical expressions are defined they are preferably defined in priority order. Each mathematical expression includes at least one physical variable. In some embodiments the mathematical expressions are Boolean expressions. A data acquisition system is configured to provide a measurement of physical parameters that correspond to the physical variables. In some embodiments the physical variables are radiation levels and the measurements of a physical parameter are radiation measurements. An execution engine is configured for sequentially reading each mathematical expression in the priority order from the data file. The execution engine then takes the measurement of the physical parameter corresponding to each physical variable and evaluates each mathematical expression by directly substituting each measurement of a physical parameter for each corresponding physical variable. The execution engine then initiates and associated actionable output if the computational result of the mathematical expression evaluates to a threshold criterion, such as TRUE or as FALSE.

### CROSS REFERENCES TO RELATED APPLICATIONS

This patent application claims priority from and is related to U.S. Provisional Patent Application Ser. No. 60/779,742 filed Mar. 7, 2006, entitled: THREAT MATRIX ANALYSIS SYSTEM. This U.S. Provisional Patent Application is incorporated by reference in its entirety herein.

### FIELD

This invention relates to the field of systems for interpreting data from instruments. More particularly, this invention relates to expert systems for analyzing radiation measurements.

### BACKGROUND

Many public and private facilities and systems are vulnerable to attack by malicious entities seeking illicit financial gain or political disruption. For example, oil and gas refineries and distribution systems, electrical power plants, airports and harbors, as well as such basic economic infrastructures such as urban centers, highway and railway transportation systems and the internet are vulnerable to such attack. In addition, such entities are also vulnerable to disruption by natural disasters and accidental causes. For example, cities and their residents are susceptible to forces of nature such as hurricanes, heat waves, and floods. Factories and public utilities involve extremely complex operations that are susceptible to accidents or malfunctions that may trigger breakdown mechanisms that have catastrophic consequences. All of these adverse developments may be generally referred to as “threats.” In order to protect citizens and government and corporate resources from such threats it is highly desirable to provide threat analysis systems that are capable of continually monitoring the environment and operation of such facilities, systems, factories, utilities and population centers, and detecting any significant threats while they can still be intercepted and neutralized with minimal negative consequences.

Some of the most serious potential threats in many countries are related to various forms of nuclear attack. Of course the most catastrophic nuclear attack would be the detonation of a nuclear weapon. However, other nuclear threats include detonation of a “dirty bomb” that distributes radioactive material over a large geographic area, or the release of radioactive material through the air or into urban water resources. Any nuclear threat requires a delivery system to transport the nuclear material to the intended target. The monitoring of transportation systems represents a good point of interdiction to prevent a nuclear catastrophe. Unfortunately, the detection of radioactive material in transportation conveyances is difficult because there are many forms of radioactive materials that require detection, and naturally occurring radioactive material can sometimes interfere with or falsely trigger standard radiation detection systems.

Due to the constant threat of terrorist attacks, countries of the world are working to deploy systems using what are typically referred to as portal monitors to screen ports of entry for any nuclear materials threat. These monitors may be placed at the borders of a country so that each person, container, vehicle, semi-truck, train, ship, car, motorized bike, bicycle, or horse drawn cart may be scanned in a non-intrusive manner and with a scanning speed set such that the normal flow of traffic is not significantly inhibited. Most portal monitors or other apparatuses used to detect radioactive material are designed to output a large amount of highly technical data. Such data are best interpreted by a subject matter expert, such as a nuclear scientist. If the operator is not at least a well-trained nuclear technician or is not specifically trained to understand any combination of data produced by these systems, the operator is not generally able to accurately interpret the data. In the case of systems for monitoring transportation networks for illicit radioactive material, it is often prohibitively expensive to provide trained nuclear technician specialists to operate the portal monitors, and it is not generally feasible for regular border personnel (or coast guard personnel or weigh station personnel) to be cross-trained in a highly technical field like nuclear engineering.

Similarly, the operation of many factories, data processing systems, utility plants, and emergency preparedness networks typically receive a continual stream of operational data and alarm indicators. These systems for evaluating the threats described and similar potentially adverse situations are collectively referred to as “systems for evaluating a physical phenomenon.” Such systems have become so complex that it is extremely difficult to interpret whether a series of alarms or abnormal operation indicators represents an impending disaster or only a temporary excursion from normal operations. Various computerized systems have been developed to interpret data from these instrumentation systems in attempts to assess whether various alarms or combinations of alarms represent real indications of an actual threat or only false alarms. Some of these computerized interpretive systems employ Boolean logic algorithms, or Boolean tables, or a system of filters to map or intersect datasets representing alarm conditions. A Boolean logic algorithm is a configuration that employs repetitions of Boolean operations over time to arrive at an estimate of a characteristic of a system. Boolean tables (also often referred to as Boolean logic tables or “truth tables”) are configurations that require matching of specific results against potential results from all possible AND/ OR/ NOR/ NAND and /XOR combinations of all these inputs in order to arrive at a conclusion about a characteristic of a system. These Boolean tables become extremely large because of the large number of inputs that are typically required in systems for evaluating threats, and because of all of the possible AND/ OR/ NOR/ NAND and /XOR combinations of each of these input elements. The process of developing such tables is very time consuming, and even the process of sifting through such extensive data to match a particular combination of data inputs consumes a lot of computational resources. In an attempt to overcome the volume of processing required by the use of Boolean tables, some other configurations define patterns representing only certain “likely” combinations of input conditions. Such systems then map or intersect datasets to try to match actual data input against these anticipated combinations. Difficulties occur with such systems when an unexpected combination of inputs occurs, and in such circumstances the system has to admit failure or has to try to approximate an answer.

Computerized neural networks have also been used in attempts to evaluate the significance of various combinations of alarms from complex instrumentation systems. However, a neural net has to go through a stage of learning. To learn, the neural net calculates weights based on the data. For each data pair to be learned, a forward pass and backwards pass is performed. This is repeated over and over again until the error is at a low enough level (or the user gives up). After all data has been applied the neural net uses these weighted values when the network is running. Consequently, to get the most accurate model, all possible real data that the neural net could ever need has to be applied to the neural network before it is placed in the field. Applying all possible values of course is not possible and takes up too much time, so during a run (when data is applied) the neural net recalculates its weighted values so that it uses its past knowledge to adjust for new information.

Fuzzy logic systems have also been used to assess data resulting from threat detection systems. Fuzzy logic uses pre-selected weighted values based on trueness and falseness of the operands in an expression. However, fuzzy logic systems typically do not produce an absolute determination of threat potential.

In view of the shortcomings of these present systems there is a need for an improved ability to reduce the profusion of data produced by threat detection systems to a simple message or a simple direction to the operator as to whether the current measurements of physical parameters by the detection system represent a critical condition for which some form of countermeasure should be initiated.

### SUMMARY

The present invention provides a first system for evaluating a physical phenomenon. The system includes a data file that defines a plurality of mathematical expressions. Each mathematical expression incorporates at least one physical variable that at least in part establishes a computational result for the mathematical expression when the mathematical expression is evaluated. Each mathematical expression also has an associated threshold criterion and an associated actionable output that is to be initiated if the mathematical expression evaluates to the threshold criterion. There is a data acquisition system that is configured for providing a measurement of a physical parameter corresponding to the at least one physical variable. An execution engine is provided, and the execution engine is configured for reading the plurality of mathematical expressions from the data file and configured for acquiring the measurement of a physical parameter corresponding to the at least one physical variable. The execution engine is further configured for evaluating each mathematical expression by directly substituting each measurement of the physical parameter for the corresponding at least one physical variable and configured for initiating the associated actionable output if the computational result of the mathematical expression evaluates to the threshold criterion.

In preferred embodiments of the first system for evaluating a physical phenomenon, the plurality of mathematical expressions is defined in priority order in the data file and the execution engine is configured for sequentially reading the plurality of mathematical expressions in priority order. In some alternative embodiments the mathematical expressions include at least one Boolean expression and the computational result is a TRUE/FALSE logic state and the threshold criterion is an actionable logical state. In some of these alternative embodiments the at least one Boolean expression incorporates a physical variable that is a pseudo physical variable that includes a subordinate Boolean expression that incorporates the at least one physical variable. In some embodiments of the first system for evaluating a physical phenomenon, the data file is a compiled binary file. In some embodiments of the first system for evaluating a physical phenomenon the system, (1) the data file defines a plurality of selected mathematical expressions, and (2) the execution engine is configured for sequentially reading the plurality of selected mathematical expressions from the data file and (3) the execution engine is configured for evaluating each selected mathematical expression by directly substituting each measurement of the physical parameter for the corresponding at least one physical variable and (4) the execution engine is configured for initiating the associated actionable output if the computational result of the selected mathematical expression evaluates to the threshold criterion. In some embodiments of the first system for evaluating a physical phenomenon, at least one mathematical expression includes expert knowledge.

A second system for evaluating a physical phenomenon is also provided. In this embodiment the system has a data file that defines a Boolean expression incorporating a physical variable that at least in part establishes a logical TRUE/FALSE state of the Boolean expression. The Boolean expression also has an associated actionable output to be initiated if the Boolean expression evaluates to an actionable logical state. There is a data acquisition system for providing a measurement of a physical parameter corresponding to the physical variable. An execution engine is also provided and the execution engine is configured for reading the Boolean expression from the data file and configured for acquiring the measurement of the physical parameter. The execution engine is further configured for directly evaluating the Boolean expression by substituting the measurement of the physical parameter for the physical variable and configured for initiating the actionable output if the logical TRUE/FALSE state of the Boolean expression evaluates to the actionable logical state.

In some embodiments of the second system for evaluating a physical phenomenon, the physical variable is a radiation level and measurement of a physical parameter is a radiation measurement. In some embodiments the Boolean expression incorporates a pseudo physical variable that includes a subordinate Boolean expression that incorporates the physical variable. In some further embodiments of the second system for evaluating a physical phenomenon, (1) the Boolean expression incorporates a plurality of physical variables, and (2) the data acquisition system provides a plurality of measurements of one or more physical parameters, with each measurement corresponding to at least one of the physical variables, and (3) the execution engine directly substitutes each measurement of the one or more physical parameters for the corresponding at least one of the physical variables. In some embodiments of the second system for evaluating a physical phenomenon, the data file is a compiled binary file, and in some embodiments the mathematical expression includes expert knowledge.

A method of evaluating a physical phenomenon is provided. The method includes a step (a) that includes creating a prioritized set of rules, incorporating in each rule at least one physical variable that at least in part establishes a computational result for the rule when the rule is evaluated in view of a measurement of a physical parameter associated with the at least one physical variable. Then, in a step (b), a threshold criterion is defined for each rule in the set of rules, and an associated actionable output is defined, where the actionable output is to be implemented if the computational result of the rule evaluates to the threshold criterion. In a further step (c), the physical parameter corresponding to the at least one physical variable in each rule is measured. Then in a step (d), each rule is evaluated by directly substituting the measurement of the physical parameter corresponding to the at least one physical variable in the rule being evaluated. The actionable output associated with the rule being evaluated is initiated if the computational result of the rule being evaluated evaluates to the threshold criterion associated with the rule being evaluated.

In some embodiments of the method, step (a) includes creating a prioritized set of rules, incorporating in one or more of the rules a plurality of physical variables that at least in part establish a computational result for the rule when the rule is evaluated in view of a measurement of the physical parameter associated with the at least one physical variable. In some embodiments the at least one rule incorporates a mathematical expression. In some embodiments of the method at least one rule includes a Boolean expression. In some embodiments of the method, the method further includes selecting a subset of the set of rules for evaluation, step (c) includes measuring a physical parameter corresponding to the at least one physical variable in each rule in the selected subset of the set of rules, and step (d) includes evaluating each rule in the selected subset of the set of rules by directly substituting the measurement of the physical parameter corresponding to the at least one physical variable in the rule being evaluated and initiating the actionable output with the rule being evaluated if the computational result of the rule being evaluated evaluates to the threshold criterion associated with the rule being evaluated. Some embodiments of the method further include a step (b-1): selecting for evaluation a subset of the physical variables that at least in part establishes a computational result for at least one rule when the at least one rule is evaluated, and a step (b-2): selecting for evaluation a subset of the set of rules, where the subset of the set of rules includes each rule in the set of rules that incorporates physical variables corresponding only to physical variables in the subset of physical variables. In these embodiments step (c) includes measuring a physical parameter corresponding to the at least one physical variable in each rule in the subset of the set of rules, and step (d) includes evaluating each rule in the subset of the set of rules by directly substituting the measurement of the physical parameter corresponding to each at least one physical variable in the rule being evaluated and initiating the associated actionable output if the computational result of each selected mathematical expression evaluates to the threshold criterion associated with the rule being evaluated. In some embodiments of the method, the method further includes step (b-1): verifying availability of the measurement of a physical parameter corresponding to the at least one physical variable and a step (b-2): initiating an actionable output if the measurement of the physical parameter corresponding to the at least one physical variable is not available.

### BRIEF DESCRIPTION OF THE DRAWINGS

Various advantages are apparent by reference to the detailed description in conjunction with the figures, wherein elements are not to scale so as to more clearly show the details, wherein like reference numbers indicate like elements throughout the several views, and wherein:

FIG. 1 is an overview of an embodiment of a system for evaluating a physical phenomenon.

FIG. 2 is a detailed view of an embodiment of a system for evaluating a physical phenomenon.

FIG. 3 is detailed view of an alternative embodiment of system for evaluating a physical phenomenon.

FIG. 4 is a flow chart of an embodiment of a method for evaluating a physical phenomenon.

FIGS. 5-17 present computer screen shots of a specific computerized embodiment of a threat matrix analysis system for evaluating a nuclear radiation physical phenomenon.

FIG. 5 is a representation of a main menu of the computerized embodiment.

FIG. 6A is a left side computer screen portion depicting a threat matrix under the computerized embodiment, and FIG. 6B is a right side portion of the computer screen corresponding to FIG. 6A.

FIG. 7 is a computer data entry screen for creating threat analysis rules in the computerized embodiment.

FIG. 8 is a computer data entry screen for setting priorities of the threat analysis rules in FIG. 7.

FIG. 9 is a computer screen summarizing threats by rule number, according to the computerized embodiment.

FIG. 10 is a computer screen summarizing threats by color code, according to the computerized embodiment.

FIG. 11 is a data entry screen for selecting a spectrum library, according to the computerized embodiment.

FIG. 12 is a computer screen for entering vehicle information, according to the computerized embodiment.

FIG. 13 is a computer screen illustrating an extension of the main menu of FIG. 5, showing an option for regenerating the threat matrix tables, according to the computerized embodiment.

FIG. 14 is a computer screen requesting operator confirmation of intent to regenerate the threat matrix tables, according to the computerized embodiment.

FIG. 15 is a computer screen requesting operator confirmation of intent to transfer a threat matrix table from a rules development environment to a production environment, according to the computerized embodiment.

FIG. 16 is a computer screen indicating progress in the transfer of the threat matrix table from a rules development environment to a production environment, according to the computerized embodiment.

FIG. 17 is computer screen advising the operator that the transfer of the threat matrix to the production environment has completed successfully, according to the computerized embodiment.

### DETAILED DESCRIPTION

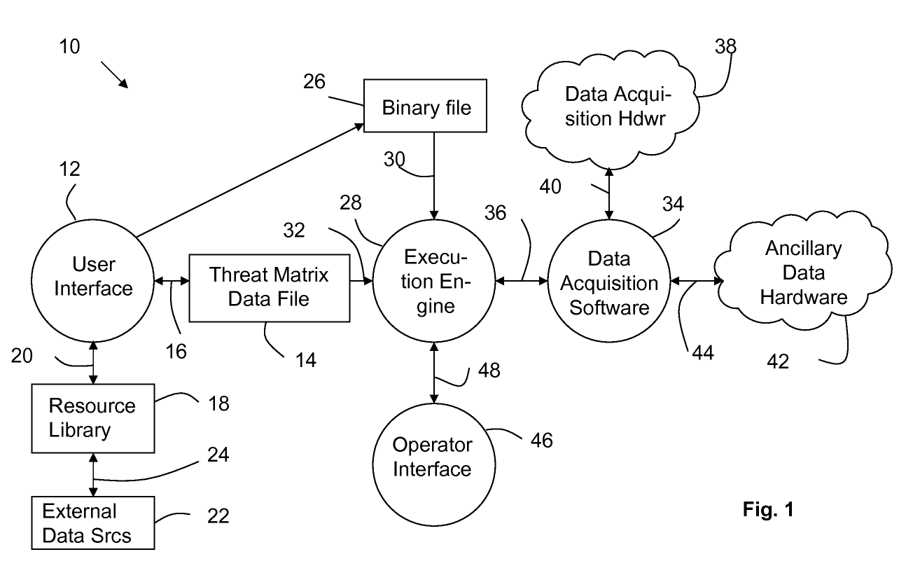

The previously-described need for improved systems capable of reducing the profusion of data typically produced by threat detection systems to a simple instruction to an operator is met by various embodiments described herein. FIG. 1 illustrates an overview of such an embodiment, system 10. System 10 includes a user interface 12. Preferably the user interface 12 is operated by a person having expert knowledge in the technical field for which the system is designed. Typically the user interface 12 includes software that runs on a processor such as a workstation or a personal computer.

The user interface 12 is used to define a least one rule that determines whether a threat exists, and each rule is stored in a threat matrix 14 data file linked to user interface 12 via link 16. As used herein the term “linked” refers to either a direct electronic communication between two system elements, or to an indirect communication between the two system elements through one or more intermediary elements that may not be illustrated. In some embodiments each rule that determines whether a threat exists comprises a mathematical expression. An example of a mathematical expression is illustrated in Expression 1 (Expr'n 1 where the terms rᵢ and Iᵢ (for i=1, 2, and 3) are examples of physical variables.

r₁*I₁+r₂*I₂+r₃*I₃ (Expr'n 1)

The physical variable rᵢ may, for purposes of illustration, be the rate of occurrence of an event “i” and Iᵢ may be the average intensity of event “i.” A “computational result” associated with Expr'n 1 is determined by substituting measured values for rᵢ and Iᵢ (where i=1, 2 & 3) into Expr'n 1 and summing the products as defined in the mathematical expression. In the case of Expr'n 1 the computational result will be number (e.g., “1586.3”) with units of measure appropriate for the computation.

Most preferably, the rules in the threat matrix 14 data file are defined as Boolean expressions. An example of a Boolean expression (using parameters comparable to those in Expr'n 1) is illustrated in Expr'n 2.

r₁*I₁+r₂*I₂+r₃*I₃>1500 (Expr'n 2)

In the case of a Boolean expression, the computational result is a logical TRUE/FALSE state. That is, the computational result of a Boolean expression is a logical state selected from states consisting of TRUE and FALSE. The specific computational result of Expr'n 2 is determined by substituting measured values for rᵢ and Iᵢ (where i=1, 2 & 3) into Expr'n 2 and summing products as defined in the Boolean expression. For Expr'n 2 the computational result is “TRUE” if r₁*I₁+r₂*I₂+r₃*I₃>1500. The computational result is “FALSE” if r₁*I₁+r₂*I₂+r₃*I₃<=1500.

Another example of a Boolean expression is presented in Expr'n 3:

Detector Operational (Expr'n 3)

### Expr'n 3 evaluates as “TRUE” if the detector is operating normally or evaluates as “FALSE” if the detector is inoperable or is not present in the system.

Boolean expressions may also include Boolean logical operators such as NOT/ AND/ OR/ NOR/ NAND and /XOR. An example of such a Boolean expression is

(s₁+s₂>s₂+s₃) AND (s₃+s₄>s₄+s₅) (Expr'n 4)

The computational result of Expr'n 4 is determined by substituting measured values for sᵢ (where i=1, 2, 3, 4, and 5) into Expr'n 4 and summing and comparing the terms defined in the mathematical expression. In the case of Expr'n 4 the computational result is “TRUE” only if (s₁+s₂>s₂+s₃) and (s₃+s₄>s₄+s₅). The computational result of Expr'n 4 is “FALSE” if s₁+s₂<=s₂+s₃ or if s₃+s₄<=s₄+s₅. The computational result of Expr'n 4 is also “FALSE” if s₁+s₂<=s₂+s₃ and s₃+s₄<=s₄+s₅.

As described in more detail later herein, a threshold criterion may be associated with each rule in the threat matrix. In the case of a mathematical expression the threshold criterion may be a numerical value (e.g., “1500”), a range (e.g., “1200 to 1800”), or a limit (e.g. “>1500”). The threshold criterion associated with a Boolean expression may be defined to be “TRUE,” or the threshold criterion associated with the Boolean expression may be defined to be “FALSE.” There is no other threshold criterion applicable to a Boolean expression as the term is used herein. These two Boolean expression threshold criteria are each referred to as an “actionable logic state.” This is to say that if the threshold criterion (i.e., the actionable logical state) for a Boolean expression is TRUE and the computational result (i.e., the logical TRUE/FALSE state) of the Boolean expression is TRUE, then the computational result of the Boolean expression is said to evaluate to the threshold criterion. If the threshold criterion (i.e., the actionable logical state) for a Boolean expression is FALSE and the computational result (i.e., the logical TRUE/FALSE state) of the Boolean expression is FALSE, then the computational result is said to evaluate to the threshold criterion. With any other combination of threshold criterion and computational result for the Boolean expression (e.g., FALSE and TRUE respectively, or TRUE and FALSE respectively), the computational result does not “evaluate to the threshold criterion;” in other words the logical TRUE/FALSE state of the Boolean expression does not evaluate to the actionable logic state.

Suppose, for example, that a rule is based on the mathematical expression of Expr'n 1, and the threshold criterion is “>1500.” Further suppose that the measurements of physical parameters depicted in Table 1 are acquired and applied (with units of measure appropriate for the computation but omitted here for simplicity).

TABLE 1

| | |
|---|---|
| r₁ = 10 | I₁ = 15 |
| r₂ = 5 | I₂ = 250 |
| r₃ = 20 | I₃ = 10 |

Substituting these measurements of physical parameters into the respective physical variables of Expr'n 1 yields the computational result defined in Expr'n 5.

10*15+5*250+20*10=150+1250+200=1600 (Expr'n 5)

### In this example the computational result (1600) does “evaluate to the threshold criterion” because the computational result 1600 is >1500.

Suppose, as a further example, that a rule is based on the Boolean expression of Expr'n 2, and that the threshold criterion is “TRUE,” and that the measurements of physical parameters of Table 1 are acquired and applied. Since, in this example, r₁*I₁+r₂*I₂+r₃*I₃>1500, Expr'n 2 does “evaluate to the threshold criterion” because when evaluated with the measurements of physical parameters listed in Table 1 the logical TRUE/FALSE state of Expr'n 2 is “TRUE.”

Rules may contain combinations of logical operations that establish a Boolean expression. A logical operation may include a test of a combination of inputs that have values of “TRUE” or “FALSE.” The logical operation may then evaluate the inputs according to the rule and produce a computational result that is “TRUE” or “FALSE.” A logical operation may examine two text strings to see if they are alike or different, resulting in a “TRUE” computational result if they are alike or a “FALSE” computational result if they are different. A logical operation may evaluate a mathematical expression using numeric inputs that are evaluated to produce a numerical computational result. The result may then be checked against a threshold criterion to produce a “TRUE” or “FALSE” computational result.

As described in more detail later herein, actionable output may be associated with each rule in a threat matrix. Actionable output is information that is sent to an operator of the system if the computational result of the mathematical expression evaluates to the threshold criterion. Examples of actionable output are (a) illumination of a red warning light, or (b) sounding of a buzzer, or (c) displaying a screen message, “WARNING—STOP VEHICLE.”

Returning to FIG. 1, user interface 12 is linked to a resource library 18 through a link 20. Preferably resource library 18 is stored on an internal hard drive accessible by the user interface 12 through link 20. However in some embodiments the resource library 18 is an external database and link 20 is a network link. Resource library 18 may access information from external data sources 22 through link 24. The resource library 18 is used in the user interface 12 to assist the user in defining rules that are stored in the threat matrix 14 data file.

Also as indicated in FIG. 1, in preferable configurations the user interface 12 compiles the threat matrix 14 as a binary file 26. A binary file is preferred because it executes much faster than an arrangement where the threat matrix is tabulated and interpreted with each application. Also, a binary file requires less data storage space which is an advantage for applications using small, portable computational hardware.

The system 10 also includes an execution engine 28. Depending on how the execution engine 28 is programmed, the execution engine 28 reads the rules, preferably in sequential order, either from the binary file 26 using link 30 or from the uncompiled threat matrix 14 using link 32. The execution engine 28 also communicates with data acquisition software 34 over link 36. Data acquisition software acquires measurements of one or more physical parameters from data acquisition hardware 38 over link 40, and/or from ancillary data hardware 42 over link 44. In some embodiments, a measurement of a physical parameter may be acquired from virtual sensor data located on a network, on the internet or in a file. Also in some embodiments the data acquisition software 34 may store the measurement of a physical parameter in a data file and the execution engine 28 may acquire the measurement of the physical parameter from the data file. Examples of measurement of a physical parameter that may be acquired from data acquisition hardware 38 are neutron densities and gamma ray flux. Examples of a measurement of a physical parameter that may be acquired from ancillary data hardware 42 are barometric pressure and vehicle weight. An example of a measurement of a physical parameter that may be acquired from a virtual sensor is information about a semi-truck's GPS data which comes from a trucking company's computer system. Preferably, the measurements of physical parameters acquired through the data acquisition software 34 and (if employed) acquired through a network, from the internet, or from a file correspond one-to-one with the physical variables that at least in part establish the computational result for the mathematical expression of each rule in the threat matrix 14.

As illustrated in FIG. 1, an operator interface 46 is linked to the execution engine 28 via link 48. Any actionable output generated by the execution engine 28 is typically activated at the operator interface 46. Operator interface 46 generally operates software that runs on a computation processor such as a workstation or a personal computer, and generally this workstation or personal computer is not the same workstation or personal computer that runs the user interface 12 software which can be used by the subject matter expert.

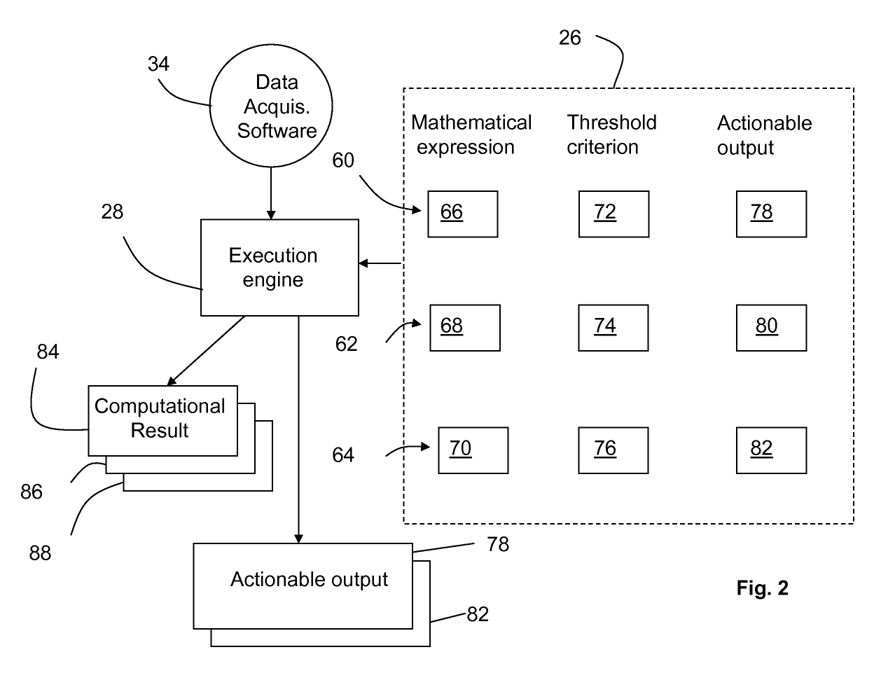

FIG. 2 illustrates further details of an embodiment of a system for evaluating a physical phenomenon, using a threat matrix. Here, execution engine 28 is evaluating a threat matrix 26 in view of data acquired by data acquisition software 34. Threat matrix 26 includes three rules: 60, 62, and 64. Each rule 60, 62, and 64 assesses a specific different threat. In this most preferred embodiment, rules 60, 62, and 64 are ranked in a priority order, and rule 60, 62, and 64 are shown in FIG. 2 in priority sequence. In the most preferred embodiments, “priority order” refers to an ordering wherein the threat posed by factors assessed in the top-ranked rule has the most serious consequences of the threats being evaluated by the system. Similarly, the threat posed by the second-ranked rule has the second most serious consequence; the threat posed by the third-ranked rule has the third most serious consequence, etc. However, in some embodiments the “priority order” is defined by some other criteria related to urgency that is established by a subject-matter expert. For example, in applications involving immediate threats to human life, priority order may be established based upon taking actions first that will likely save the most lives. Ranking rules in a priority order is particularly beneficial because the operator of the system can be easily trained regarding how to handle threats posed at different priority levels.

For each rule 60, 62, and 64 in threat matrix 26, a mathematical expression (66, 68, and 70, respectively) is defined, as well as a threshold criterion (72, 74, and 76, respectively), and an actionable output (78, 80, and 82, respectively). In some embodiments, particularly embodiments in which the mathematical expression is a Boolean expression, the system may be designed to presume that every rule has the same threshold criterion (e.g., “TRUE), and in such systems it is not necessary to repetitively redefine this same threshold criterion for each rule. Each mathematical expression 66, 68, and 70 incorporates at least one physical variable that at least in part establishes a computational result for the mathematical expression when the mathematical expression is evaluated. Execution engine 28 acquires the measurement of a physical parameter corresponding to each physical variable from the data acquisition software 34, and evaluates the mathematical expression (e.g., 66, 68, 70) for each rule (e.g., 60, 62, 64) by substituting (typically, directly substituting) the measurement of a physical parameter for each corresponding physical variable to arrive at a computational result (e.g., 84, 86, 88) for each rule. FIG. 2 depicts a hypothetical situation wherein the computational result 84 for mathematical expression 66 evaluates to threshold criterion 72, the computational result 86 for mathematical expression 68 does not evaluate to threshold criterion 74, and the computational result 88 for mathematical expression 70 does evaluate to threshold criterion 76. In view of this hypothetical situation, actionable outputs 78 and 82 are initiated, and actionable output 80 is not initiated.

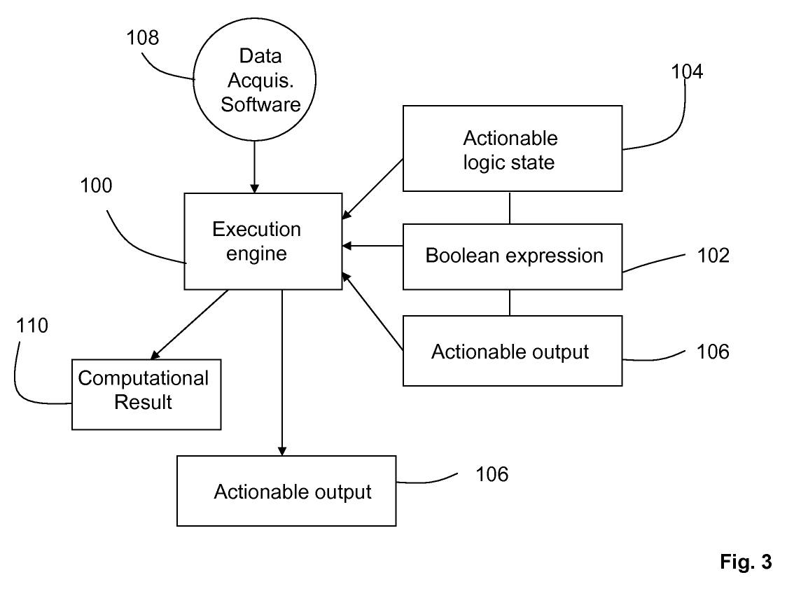

FIG. 3 illustrates an alternative embodiment wherein an execution engine 100 is configured to evaluate a Boolean expression 102 that incorporates a physical variable that at least in part establishes a logical TRUE/FALSE state of the Boolean expression. Boolean expression 102 has an actionable logic state 104 and an actionable output 106. Execution engine 100 acquires a measurement of a physical parameter corresponding to the physical variable from data acquisition software 108, and substitutes that measurement into the Boolean expression 102, and derives a computational result 110. The execution engine 100 then compares the computational result 110 with the actionable logic state 104, and if the computational result 110 evaluates to the actionable logic state 104 (as it does in the example of FIG. 3), then the actionable output 106 is initiated. An important characteristic of the embodiment of FIG. 3 is that the initiation of an actionable result in response to the evaluation of a rule assessing a threat is a binary (TRUE or FALSE) decision that is determined by a direct evaluation of a single Boolean expression.

A system that is configured for directly evaluating a Boolean expression is preferred over various configurations that do not directly evaluate a Boolean expression, such as configurations that utilize Boolean logic algorithms, or configurations that utilize Boolean tables, or configurations that utilize a system of filters to map or intersect datasets. A Boolean logic algorithm is a configuration that employs repetitions of Boolean operations over time to arrive at an estimate of a characteristic of a system. Such systems are slower than systems that are configured for directly evaluating a Boolean expression to make a determinative decision of whether the threat is present. Boolean tables (also often referred to as Boolean logic tables or “truth tables”) are configurations that require matching of specific results against potential results from all possible NOT/ AND/ OR/ NOR/ NAND and /XOR combinations of all these inputs in order to arrive at a conclusion about a characteristic of a system. These Boolean tables become extremely large because of the large number of inputs that are typically required in systems for evaluating threats, and because of all of the possible NOT/ AND/ OR/ NOR/ NAND and /XOR combinations of each of these input elements. The process of developing such tables is very time consuming, and even the process of sifting through such extensive data to match a particular combination of data inputs consumes a lot of computational resources. In an attempt to overcome the volume of processing required by the use of Boolean tables some other configurations define patterns representing only certain “likely” combinations of input conditions. Such systems then map or intersect datasets to try to match actual data input against these anticipated combinations. Difficulties occur with such systems when an unexpected combination of inputs occurs, and in such circumstances the system has to admit failure or has to try to approximate an answer. As a result of these shortcomings a system that is configured for directly evaluating a Boolean expression is distinct and much preferred over configurations that utilize Boolean logic algorithms, Boolean tables, or a system of filters to map or intersect datasets.

A system that is configured for directly evaluating a Boolean expression is also much preferred over systems that utilize neural networks in an attempt to reduce a profusion of technical data into actionable output. A neural net has to go through a stage of learning. To learn, the neural net calculates weights based on the data. For each data pair to be learned a forward pass and backwards pass is performed. This is repeated over and over again until the error is at a low enough level (or the user gives up). After all data has been applied the neural net uses these weighted values when the network is running. Consequently, to get the most accurate model, all possible real data that the neural net could ever need has to be applied to the neural network before it is placed in the field. Applying all possible values of course is not possible and takes up too much time, so during a run (when data is applied) the neural net recalculates its weighted values so that it uses its past knowledge to adjust for new information. In contrast a system that is configured for directly evaluating a Boolean expression does not require a learning stage like neural nets nor does it use weighted values. Therefore a system that is configured for directly evaluating a Boolean expression is distinct and much preferred over neural network systems.

A system that is configured for directly evaluating a Boolean expression is also much preferred over systems that employ fuzzy logic. Fuzzy logic uses pre-selected weighted values on trueness and falseness of the operands in an expression. Fuzzy logic does not produce absolute solutions to Boolean expressions. Therefore a system that is configured for directly evaluating a Boolean expression is distinct and much preferred over fuzzy logic systems.

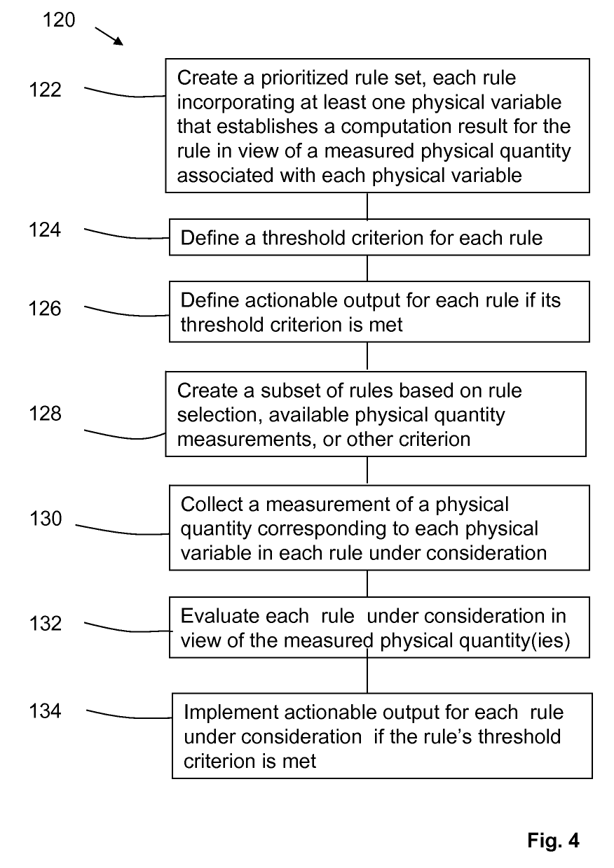

FIG. 4 illustrates a method according to a preferred embodiment, process 120. In step 122 of process 120, a prioritized rule set is created, where each rule incorporates at least one physical variable that establishes a computation result for the rule in view of a measured physical parameter associated with each physical variable. In step 124, a threshold criterion is defined for each rule, and in step 126, an actionable output is defined for each rule, the actionable output to be initiated if that rule's threshold criterion is met. Process 120 may include a step 128 in which a subset of the rules created in step 122 is created. The creation of this subset may be based upon a manual or automated rule selection, based upon the availability of actual physical parameter measurements, or one or more other criteria. If step 128 is employed then the rules resulting in the subset of rules are termed the “rules under consideration.” If step 128 is not employed, then all the rules in the original set of rules created in step 122 are termed the “rules under consideration.” In step 130, a measurement of a physical quantity corresponding to each physical variable in each rule is collected. In step 132, each rule under consideration is evaluated in view of one or more measured physical parameters. If a rule employs only one physical variable corresponding to one measured physical parameter, then the rule is evaluated in terms of that one measured physical parameter. If a rule employs multiple physical variables corresponding to multiple measured physical parameters, then the rule is evaluated in terms of each measured physical parameter corresponding to each physical variable in that rule. In step 134, an actionable output is initiated for each rule under consideration if the rule's threshold criterion is met when each measured physical parameter is substituted for each corresponding physical variable in the rule.

### EXAMPLE

A specific implementation of a system for evaluating a physical phenomenon has been developed in software entitled “Threat Matrix.” This system is specifically designed for application with nuclear radiation detection equipment to evaluate the potential threat of illicit nuclear material being clandestinely conveyed by ships, aircraft, land vehicles or carried on the person of individuals. Since the inspection personnel typically do not have the expertise required to interpret the output of radiation detection instruments, the Threat Matrix software captures the knowledge of an expert and reduces the multitude of data produced by the detection system to a simple message or a simple instruction to the operator as “actionable output.” That is, the system permits subject matter experts in fields such as spectroscopy analysis; detector data; or any generalized real-time data acquisition system that produces patterns for analysis, to codify patterns in a way that converts raw data into actionable output. The subject matter expert may specify an arbitrary set of rules (knowledge capture) which an execution engine translates into results that can he acted upon either automatically or through a non-expert operator. Each rule is specified in a free form Boolean expression that includes intermediate evaluation of Booleans, numeric figures, mathematical functions, or string comparisons, and allows evaluation of separately-defined expressions as pseudo sensors. The actionable output message or instruction typically advises the operator whether the current vehicle/semi-truck/SUV/bicycle/motorized bike/container/ship/person/horse drawn cart/should be diverted for further examinations or scans by a qualified nuclear operator to determine if a legitimate threat exists. The Threat Matrix analysis system may be located at airports, harbors, truck stops, police check points, office building security departments, in mobile devices for Naval ships (i.e. back packs, brief cases, etc.) or used in a border crossing portal system to detect dirty bomb or special nuclear materials.

The Threat Matrix application is composed of two pieces of software, a Subject Matter Expert User Interface and an Execution Engine. Among the beneficial features of the software is the ability to link with other external databases that hold additional information which may be used by the subject matter expert when developing a rule. In addition, ancillary data subsystems may be attached directly to the acquisition system software and raw data from the ancillary subsystems may be incorporated into the Threat Matrix. Different setups of Threat Inputs may be established based upon the attached acquisition systems hardware. Also, the system permits definition of different Threat Input types. A threat input type indicates what types of data are expected. For example, a Boolean data type would be expected for the expression “point source detected,” a single precision variable would be expected as the confidence level for “Nuclide Identified,” and a long data type would be expected for tri-state threat inputs. In addition, pseudo sensors may be defined. A pseudo sensor is a Boolean expression containing any combination of other pseudo sensors, threat inputs, constants, math functions, a string, or Booleans as its operands. At its basic level a pseudo sensor could just be a constant. But more generally, a pseudo sensor is a free-form Boolean expression that consists of any defined threat inputs as its operands but its result is fed back into another Boolean expression. Pseudo sensor results are performed before the rule set is evaluated.

The User Interface (also referred to as a Subject Matter Expert Interface) is used to define rule sets based upon threat inputs, and its operation will be described in further detail later herein. The Execution Engine uses an ActiveX dynamic link library (dll) to acquire the physical measurements from data acquisition software and to execute the pre-defined rules. The Execution Engine is responsible for connecting the real data to the threat inputs defined in the Boolean expression and evaluating the rule set for the current set of real-time data. The Execution Engine also returns the results of all the rules in the set and indicates if the rule was evaluated with the current real-time data and what the value of the operands in the Boolean expression were during the evaluation. The sub-results of a Boolean expression may also be returned for each rule by the Execution Engine.

There are four phases of operation of the Threat Matrix software: Definition; Implementation; Execution, and Retrieval. In the Definition Phase a subject matter expert specifies all detection input streams (i.e., all sensor and ancillary subsystems) that are made available to the Threat Matrix User Interface and to the Threat Matrix Execution Engine. The subject matter expert also defines individual mathematical expressions that make up a rule set. A mathematical expression may be Boolean, arithmetic, mathematical functions, text or string, or intermediate pseudo sensor data. The rule set captures the knowledge of the subject matter expert in the form of equations expressed through Boolean expressions. These rules acting together reduce the profusion of information (detection) streams into a set of actionable information that is sent to an operator interface. In the Definition Phase the subject matter expert also defines specific rules to be evaluated by the Execution Engine in a priority order defined by the expert, and the subject matter expert also defines a specific actionable output to be implemented for each rule if the computational result evaluates to a threshold criterion (e.g., “TRUE). An actionable output may, for example, be (a) playing of a particular “.wav” (voice) file, (b) displaying a specific message, (c) turning on a colored light, or (d) producing a particular numeric message. The subject matter expert also determines which rules and inputs are enabled or disabled for a specific Threat Matrix implementation. Finally, in the Definition Phase the subject matter expert may also execute a command to save the specified rule set into a binary file format.

In the Implementation Phase the instrumentation suite is activated and the instrumentation suite's available inputs (i.e., available measurements of physical parameters) are compared against the physical variables specified in the rules set, and the operator is advised of any inconsistencies. If there are inconsistencies the operator may be given the option of evaluating only those rules which do not incorporate a physical variable for which a corresponding measurement of a physical parameter is not available. In some embodiments the execution engine evaluates all rules and the execution engine automatically produces a specially-defined actionable output for any rule which incorporates a physical variable for which a corresponding measurement of a physical parameter is not available from the data acquisition system. In some embodiments the operator may be given the opportunity to select which rules are to be evaluated by the Execution Engine. In some embodiments the operator may be given the opportunity to select which physical variables (or to select which measurements of physical parameters) will be evaluated, and then the only rules evaluated by the Execution Engine are those rules containing only those selected physical variables (or those physical variables corresponding to the selected measurements of physical parameter). In some of these embodiments involving selection of physical parameters or measurements of physical parameters for evaluation, only those measurements of physical properties selected for evaluation are retrieved by the data acquisition system. Also in the Implementation Phase, the functionality of the hardware and software communication protocol between the threat matrix Execution Engine and the attached instrumentation system (instrumentation suite) is confirmed, and the data storage and referenced data paths are verified.

In the Execution Phase the Execution Engine acquires and validates the measurements of physical parameters from the radiation sensor and ancillary data acquisition systems. The Execution Engine then executes rules containing valid data in priority sequence, initiates the actionable output for each rule if the computational result for that rule evaluates to the threshold criterion for the rule, and stores the results of each rule evaluation and validates the storage for subsequent retrieval.

In the Retrieval Phase the operator interface subsystem retrieves the rule execution results to present for appropriate action by either automated programs or operator request.

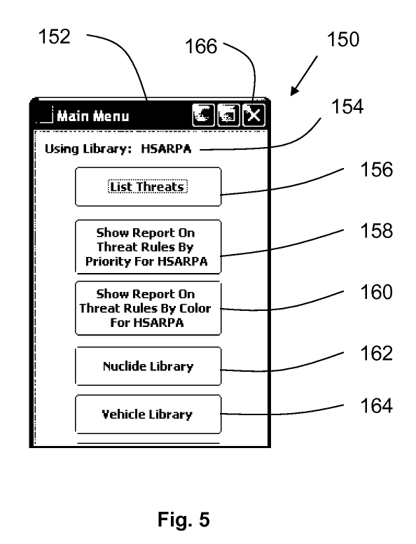

The following sections describe the menus, screens, and functions used in the Definition Phase of the Threat Matrix software. The subject matter expert (user) begins by opening the Threat Matrix User Interface program, typically by double-clicking on an icon on the desktop of a personal computer or workstation. A “splash screen” and a main menu are displayed. Then the splash screen disappears, and as depicted in FIG. 5, the main menu 150 remains. The Main Menu 150 provides the rules creation capability for the Threat Matrix program. The Threat Matrix main menu 150 opens with a title bar 152 and displays the name of the reference (nuclide) library 154 currently in use (HSARPA in this example). Any Threat Matrix Rules developed by a user are tied to a nuclide library and/or rules set name and version number. Using rule sets enables an audit trail to exist. The main menu 150 also displays five function buttons: List Threats 156, Show Report On Threat Rules by Priority For HSARPA 158, Show Report On Threat Rules By Color 160, Nuclide Library 162, and Vehicle Library 164. The user may exit the Main Menu 150 by pressing the Close [X] button 166.

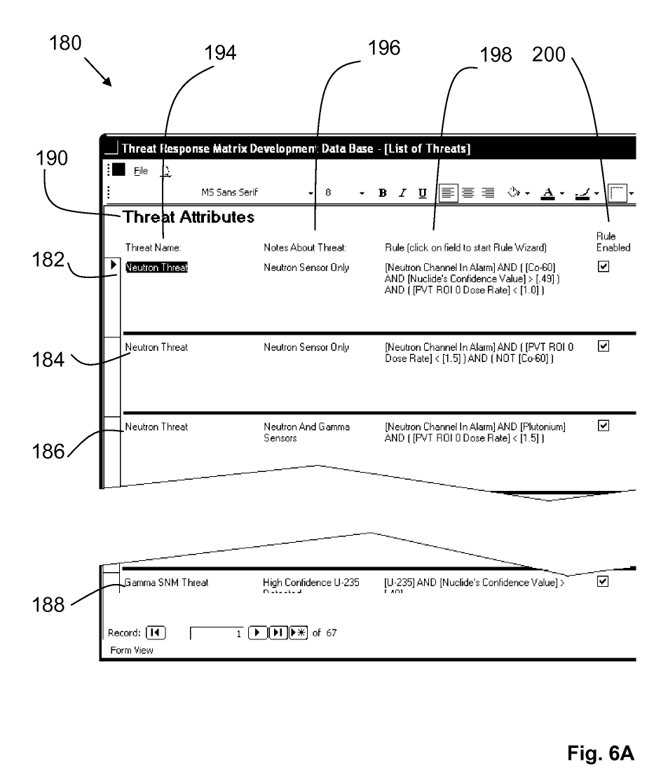

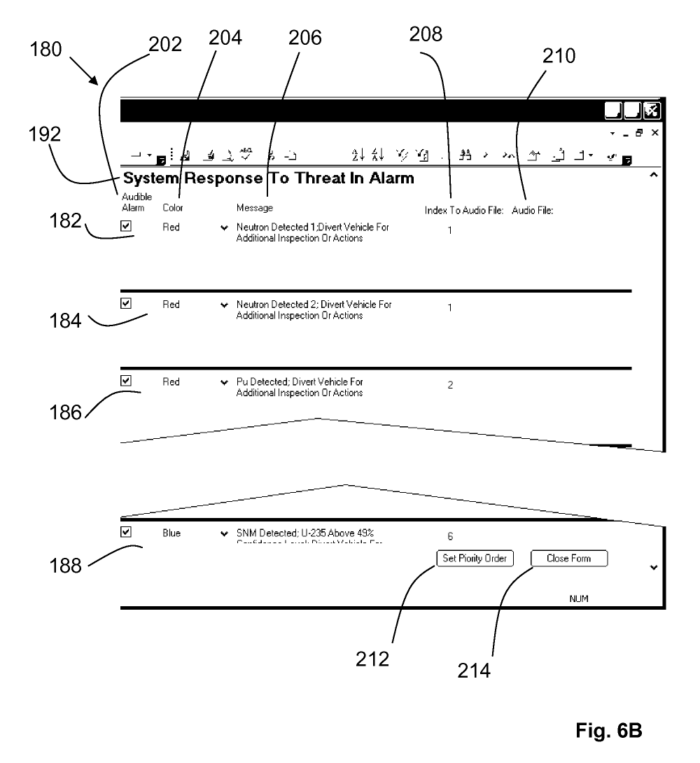

Clicking on the List Threats button 156 opens the List Threats form 180 shown in part in FIGS. 6A and 6B. The List of Threats form 180 contains a Microsoft Access Form. A series of Rules 182, 184, 186 and 188 are depicted. The two sections of the List Threats display are: Threat Attributes 190 (FIG. 6A) and System Response To Threat In Alarm 192 (FIG. 6B).

The Threat Attributes 190 section contains three fields: Threat Name 194, Notes About Threat 196, and Rule 198. In the Threat Name field 194 the user enters the name (up to 50 characters) of the Rule to be created in this field. In the Notes About Threat 196 field the user enters explanatory or descriptive information (up to 65,535 alphanumeric characters) about the Rule in this field. In the Rule field 198 the user creates the Threat Matrix Rule, using a process described in further detail later herein.

The System Response To Threat In Alarm section 192 contains six fields (columns): Rule Enabled 200 (FIG. 6A), Audible Alarm 202 (FIG. 6B), Color 204 (FIG. 6B), Message 206 (FIG. 6B), Index To Audio File 208 (FIG. 6B), and Audio File 210 (FIG. 6B). The check box in the Rule Enabled column 200 is used to select which Rules are currently included in the Rule Set, which contains all Rules to be evaluated by the Execution Engine. If the box contains a check, the associated Rule becomes part of the Rule Set, but if the checkbox is empty, the associated Rule is ignored during execution of the Rule Set. The Audible Alarm checkbox 202 is used to determine if an audible alarm will be sounded in the event a Rule is evaluated as True (i.e., considered to be in alarm). If the Audible Alarm box 202 contains a check, an audible alarm will sound if the Rule is evaluated to True, but if the checkbox is empty, the audible alarm will not sound.

The Color field 204 is used to specify the color which will be used by the Execution Engine to display the text message. Clicking on an arrow (not shown in this illustration) at the right of the text box pulls down a menu of colors (amber, blue, green, orange, red, white, and yellow) which may be chosen. This selection is useful for organizations which assign specific meaning to certain colors (e.g., blue may be used to indicate that a gamma alarm has occurred). The Message field 206 is used to enter the message that will be shown on the Execution Engine Threat Report for PORTAL screen when the Rule is evaluated as True (in alarm).

The Index To Audio File field 208 is an integer number that is used to determine the audio message the system announces over the annunciators (if audio annunciators are included as part of the system). A list of index numbers and the audio (.wav) files to which they correspond is included with the software system. Depending on the software system configuration, the full path and file name for audio (.wav) files may be entered into the Audio File field 210. When enabled, this feature permits system users to store custom audio files on the system and use those files as the audio message for the system annunciators.

As soon as the user begins typing in a field on the List of Threats form 180, the changes to the underlying table (except for the Rule field 198 which is saved by the Rules Wizard) will be saved. As long as the user has not tabbed to the next field in a record or moved to another record, previous information in the field may be recovered by using the Esc key. If the user has moved to another field or record and wants to revert back to the previous value that was in that field, the information must be retyped. Note that the user may check and uncheck boxes in the Rule Enabled column 200 to establish which rules will be employed in a specific application by the Execution Engine.

Two additional buttons are provided on the List of Threats form 180 as shown in FIG. 6B: Set Priority Order 212 and Close Form 214. Clicking on the Close Form button 214 closes the List of Threats form 180. Clicking on the Set Priority Order button 212 brings up a computer screen described later herein.

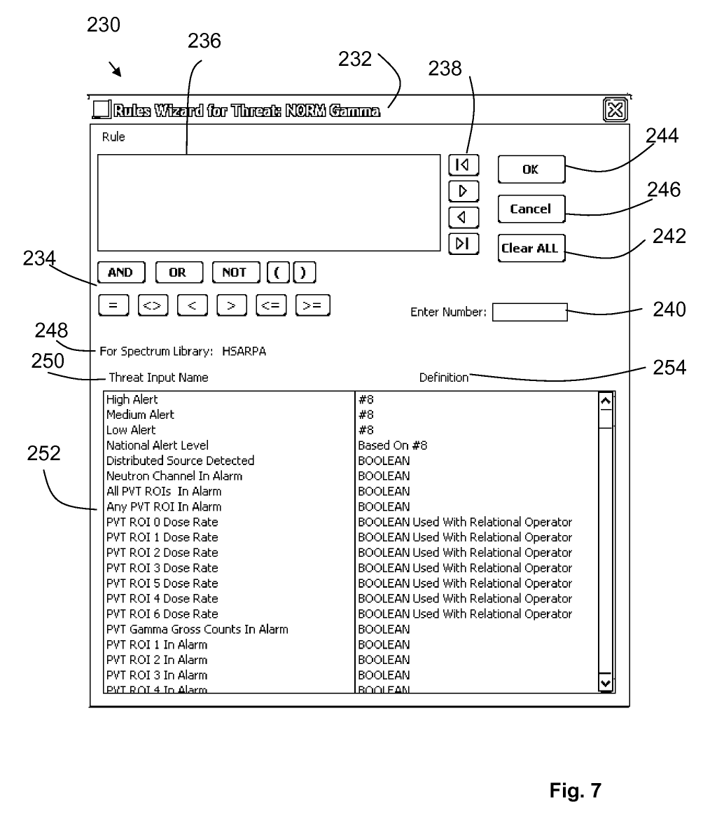

The Rule field 198 (FIG. 6A) is used to create Threat Matrix Rules. Left clicking on the Rule field opens the Rules Wizard 230 shown in FIG. 7. The threat name of the Rule currently being edited appears in the title bar 232 of the Rules Wizard 230. If adding a Rule, a name will not appear until it is added. The buttons 234 below the Rule box 236 are used to create the Rule's Boolean expression. An example Boolean expression that may be used in the Threat Matrix software is presented as Expr'n 6.

(NOT [Distributed Source Detected]) AND

([Detected Gamma 0 Dose Rate]>[50]) (Expr'n 6)

The buttons 238 to the right of the Rule box move the highlighted cursor in the Rule box 236. The box labeled Enter Number 240 is used to place a numeric value into the Boolean expression. To do so, the user may type any integer or decimal number into the box and press the Enter key. If the number cannot be found in the database, the Rules Wizard will add it into the database and insert the number into the Boolean expression. Adding a number into the database may cause a slight delay before the number appears in the Boolean expression.

If editing an existing Rule, the user presses the Clear All button 242 to erase the current Rule and reenter the Rule correctly. The user clicks the OK button 244 to have the software check and insert the added or changed Rule into the Rule field 198 (FIG. 6A). Clicking the Cancel button 246 exits the Rules Wizard without saving changes made to the Rule field 198. When the user clicks on the OK button 244, the software executes code that syntactically checks the Boolean expression and also does semantic checking of the Rule just created. If the software determines that an error has occurred, an error message will be displayed and the Rules Wizard window will be opened again so the error can be corrected. Examples of an error that may be detected are a missing set of parentheses (that is necessary in order to clarify a Boolean expression) or a missing Boolean operator.

The For Spectrum Library field 248 (FIG. 7) shows the name of the nuclide library that is presently being used. There can be different nuclide isotopes in different libraries. The software displays the nuclide isotopes that are in the named library under the Threat Input Name column 250 of the Threat Input box 252. The Threat Input box 252 lists all possible items that can be used in a Boolean expression. The Definition column 254 informs the user how entries in the Threat Input Name column 250 may be used. The user may move the mouse pointer over the Threat Input box 252 and select an entry in the Threat Input Name column 250 by left clicking on any item in the Threat Input box 252. (Once the mouse pointer is inside the box, the mouse wheel can be used to scroll through the list.)

When “BOOLEAN” is listed in the Definition column 254 it means that the threat listed in the same row in the Threat Input Name column 250 is a Threat Input that can only take on the value of TRUE or FALSE. The term “Based On #nn” in the Definition column 254 means that this is also a Threat Input but its possible values are of only #nn definition. For example, “Based On #15” denotes that this is a Threat Input but it can only be used with a relational operator of “=” and the only possible values that should be used are the Threat Inputs that have the definition of “#15.” In some embodiments the user has control over the Vehicle License Plate Number Threat Input only. The user can change these values via the main menu's Vehicle Library button. All other “Based On #nn” Threat Inputs are preferably changed via the nuclide library or by changing the setup configuration of the threat inputs.

The term of “BOOLEAN Used With Relational Operator” in the Definition column 254 refers to a Threat Input that must appear with any relational operator and a numeric value that the user enters into the Enter Number 240 box.

The term “Dependant On Appropriate BOOLEAN” in the Definition column 254 refers to a Threat Input generated by the software: Detected Gamma Difference Value, Nuclide's Category, and Nuclide's Confidence Value. In the preferred embodiment, these Threat Inputs appear in the same Rule with a mate Threat Input. For example, both Nuclide's Category and Nuclide's Confidence Value (if used) preferably have a nuclide isotope placed in the Rule before it is used with a relational operator, as illustrated in Expr'n 7.

[Am-241] AND ([Nuclide's Confidence Value]>[0.95]) (Expr'n 7)

In this example the nuclide isotope being used is Am-241. If the nuclide isotope is left out, the software will display an error message. Therefore whenever a “Dependant On Appropriate BOOLEAN” expression is used, the “BOOLEAN” threat input must be placed before the “Dependant On Appropriate BOOLEAN” Threat Input and separated by the “AND” operator.

Another example is depicted as Expr'n 8.

([Ga-67] AND ([Nuclide's Category]=[Special Nuclear Material])) (Expr'n 8)

This example shows the use of “Nuclide's Category” Threat Input. This Threat Input depends on a nuclide isotope being identified. Note that “Ga-67” is used in the Rule before “Nuclide's Category” and the “AND” operator is used. The “AND” operator is the only operator that should be used with the “Dependant On Appropriate BOOLEAN” Threat Input and its mate Threat Input (i.e., nuclide isotope or Detected Gamma region).

A further example is shown in Expr'n 9.

([Detected Gamma Difference 1 In Alarm] AND

([Detected Gamma Difference Value]>[0.01])) (Expr'n 9)

In this example, the “Dependant On Appropriate BOOLEAN” is the “Detected Gamma Difference Value” and its mate Threat Input is “Detected Gamma Difference 1 In Alarm”. Any of the “Detected Gamma Difference X In Alarm” statements could be used as the mate Threat Input (where the value of X is from 1 to 5). The Nuclide's Category Threat Input must use the “=” operator, while the Nuclide's Confidence Value and Detected Gamma Difference Value can use any of the relational operators. Presently, the Threat Input National Alert Level must use the “=” operator since its definition is “Based On #n.” Other Threat Inputs that must use the “=” operator are: “All Nuclide Categories,” “Any Nuclide Category,” “Vehicle's License Plate Number From Camera 1,” “Vehicle's License Plate Number From Camera 2,” and “Vehicle's License Plate Number From Camera 3.”

The software generates some Threat Inputs that warrant special explanations, such as “ANY” and “ALL.” Examples of these Threat Inputs include, “All Detected Gammas In Alarm,” “Any Detected Gamma In Alarm,” “All Detected Gamma Difference Values,” “Any Detected Gamma Difference Value,” “All Detected Gamma Differences In Alarm,” “Any Detected Gamma Difference In Alarm,” “Any Nuclide Identified,” “All Nuclide Categories,” “Any Nuclide Category,” “All Nuclide Confidence Values,” and “Any Nuclide Confidence Value.” Basically any Threat Input with the word “All” or “Any” in the name implies some number of Threat Inputs can be grouped together. For example, the Threat Input “Detected Gamma 1 In Alarm” is in the same group as “Detected Gamma 2 In Alarm.” The “Any” means that any member of a group can be combined with an “OR” operator in one Boolean expression. Therefore, the software automatically expands these Threat Inputs. For example, “Any Detected Gamma In Alarm” gets expanded to Expr'n 10.

([PVT Gamma Gross Counts In Alarm] OR

[Detected Gamma 1 In Alarm] OR

[Detected Gamma 2 In Alarm] OR

[Detected Gamma 3 In Alarm] OR

[Detected Gamma 4 In Alarm] OR [Detected Gamma 5 In Alarm] OR

[Detected Gamma 6 In Alarm]) (Expr'n 10)

The “All” means that any member of a group can be combined with an “AND” operator in one Boolean expression. For example, “All Detected Gammas In Alarm” gets expanded to Expr'n 11.

([PVT Gamma Gross Counts In Alarm] AND

[Detected Gamma 1 In Alarm] AND

[Detected Gamma 2 In Alarm] AND

[Detected Gamma 3 In Alarm] AND

[Detected Gamma 4 In Alarm] AND

[Detected Gamma 5 In Alarm] AND

[Detected Gamma 6 In Alarm]) (Expr'n 11)

Therefore, an “Any” is combining items in a group with an “OR” operator and an “All” is combining items in a group with an “AND” operator. Examples of groups that are enabled in the Threat Matrix software are Detected Gamma(s), Detected Gamma Difference(s), and Nuclide Isotopes.

There is one exception to the “Any” and “All” Rule. If the system uses spectroscopy, and a K-40 (or other) calibration source may be built into the hardware, the execution engine may be configured to not include K-40 into the “Any” Rule. For example, in a system configured for spectroscopy with K-40 used as a calibration source, the “Any Nuclide Identified” Rule would cause the software to take all the nuclide isotopes from the specified Spectrum Library and combine all of them except K-40 with an “OR” operator. For example, if the Spectrum Library contains the nuclides in Table 2:

TABLE 2

| | | | | |
|---|---|---|---|---|
| Am-241 | Ba-133 | Co-57 | Co-60 | Cr-51 |
| Cs-137 | F-18 | Ga-67 | H-Capture | I-123 |
| I-125 | I-131 | In-111 | Ir-192 | K-40 |
| Mo-99 | Np-237 | Pd-103 | Plutonium | Pu-238 |
| Pu-240 | Pu-241 | Pu-242 | Ra-226 | Se-75 |
| Sm-153 | Sr-89 | Tc-99m | Th-232 | Tl-201 |
| U-232-aged | U-235 | U-238-aged | Xe-133 | |

and if (NOT [Any Nuclide Identified]) is used in a Rule, the software will expand it to Expr'n 12.

(NOT ([Am-241] OR [Ba-133] OR [Co-57] OR [Co-60] OR

[Cr-51] OR [Cs-137] OR [F-18] OR [Ga-67] OR [H-Capture] OR

[I-123] OR [I-125] OR [I-131] OR [In-111] OR [Ir-192] OR

[Mo-99] OR [Np-237] OR [Pd-103] OR [Plutonium] OR

[Pu-238] OR [Pu-240] OR [Pu-241] OR [Pu-242] OR

[Ra-226] OR [Se-75] OR [Sm-153] OR [Sr-89] OR

[Tc-99m] OR [Th-232] OR [Tl-201] OR [U-232-aged] OR

[U-235] OR [U-238-aged] OR [Xe-133])) (Expr'n 12)

Note that [K-40] is not included in the Boolean expression of Expr'n 11. If the Rule becomes “(NOT ([Any Nuclide Identified] OR [K-40]))” then this Rule will be expanded to Expr'n 13.

(NOT (([Am-241] OR [Ba-133] OR [Co-57] OR [Co-60] OR

[Cr-51] OR [Cs-137] OR [F-18] OR [Ga-67] OR [H-Capture] OR

[I-123] OR [I-125] OR [I-131] OR [In-111] OR [Ir-192] OR

[Mo-99] OR [Np-237] OR [Pd-103] OR [Plutonium] OR

[Pu-238] OR [Pu-240] OR [Pu-241] OR [Pu-242] OR

[Ra-226] OR [Se-75] OR [Sm-153] OR [Sr-89] OR

[Tc-99m] OR [Th-232] OR [Tl-201] OR [U-232-aged] OR

[U-235] OR [U-238-aged] OR [Xe-133]) OR [K-40])) (Expr'n 13)

### The user can force [K-40] to be included in the Boolean expression by manually adding “OR [K-40]” to the Boolean expression or configure the execution engine so that the “K-40 installed as a calibration parameter” is set to False.

When the Boolean expression has been entered into the Rule box 236 (FIG. 7), clicking the OK button 244 enables the software to check it. If the software does not find errors in the Boolean expression it will save the Rule in the Rule field 198 of the List of Threats form 180 (FIG. 6A) and then exit the Rules Wizard.

Once back at the List of Threats form 180 (FIGS. 6A and 6B), the user will normally check the status of the check box in the Rule Enabled column 200. If the check box in the Rule Enabled column 200 is unchecked, the Rule just developed will not be included in the Rules executed by the Threat Matrix Execution Engine.

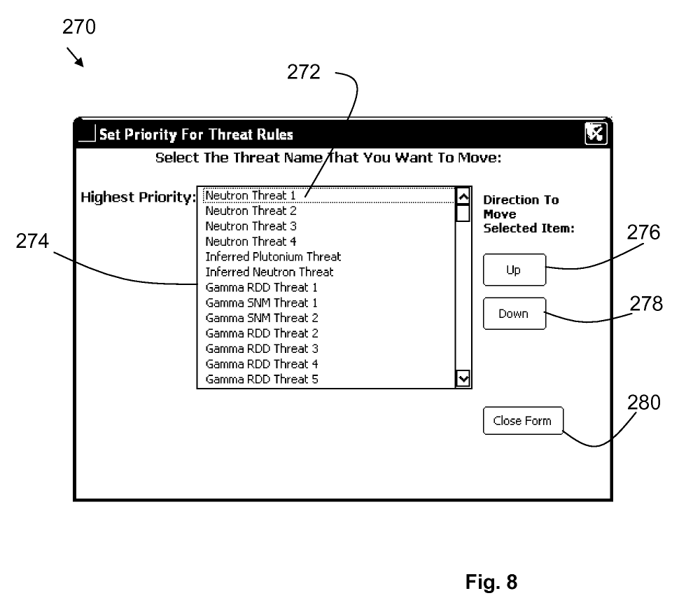

Clicking on the Set Priority Order button 212 on the List of Threats form 180 opens the screen 270 depicted in FIG. 8. Screen 270 is used to re-prioritize the threat rules established in the List of Threats form 180 of FIGS. 6A and 6B. The user selects a Threat Name (e.g., Neutron Threat 1 272) in the list 274 to be moved up or down by left-clicking on the item to highlight it. The user can select multiple Threat Names to be moved at the same time by holding down the Ctrl key while left-clicking on the items. Once the Threat Names are highlighted, the user then left-clicks on the Up 276 or Down 278 buttons to move them by one position. The items will move in the appropriate direction by one position every time the direction button is clicked. The Close Form 280 button is used to exit the form. Upon exiting the form, the software will adjust the order of the threats on the List of Threats form 180 (FIGS. 6A and 6B) automatically, and the user will be returned to the List of Threats form 180. From there the user may press the Close Form button 214 to return to the Main Menu 150 (FIG. 5).

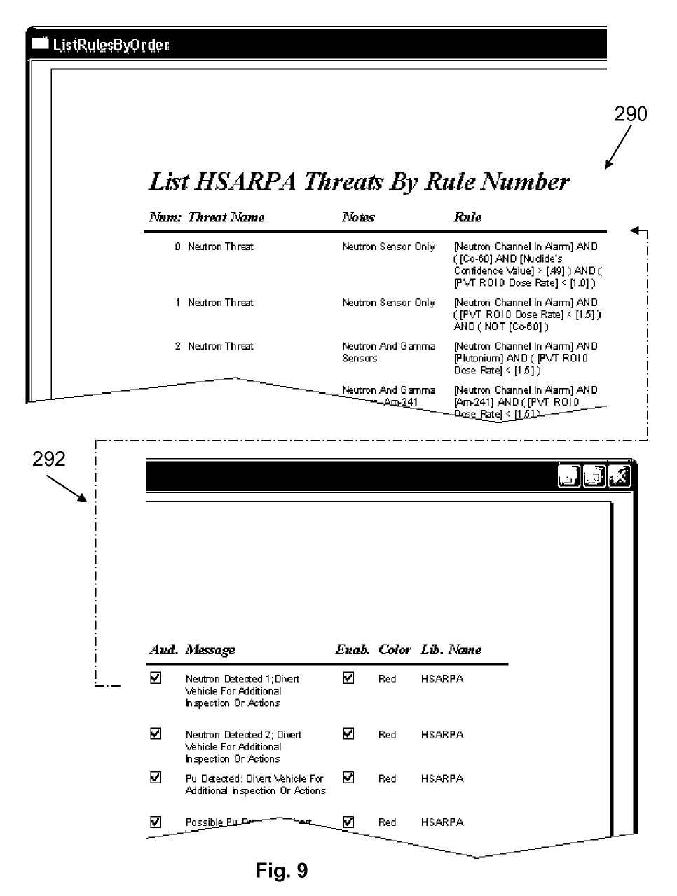

The Main Menu 150 of FIG. 5 includes two buttons for generating reports. Clicking on the Show Report On Threat Rules By Priority For HSARPA button 158 opens a window depicted in part in FIG. 9, listing the Rules in priority order. Shown in FIG. 9 are a left portion 290 and a right portion 292 of a print preview screen. From this print preview screen, the complete list or selected pages may be printed. Clicking on File at the upper left side of the window opens the normal Windows print menu, and the normal page selection and printing procedure may be followed from this point.

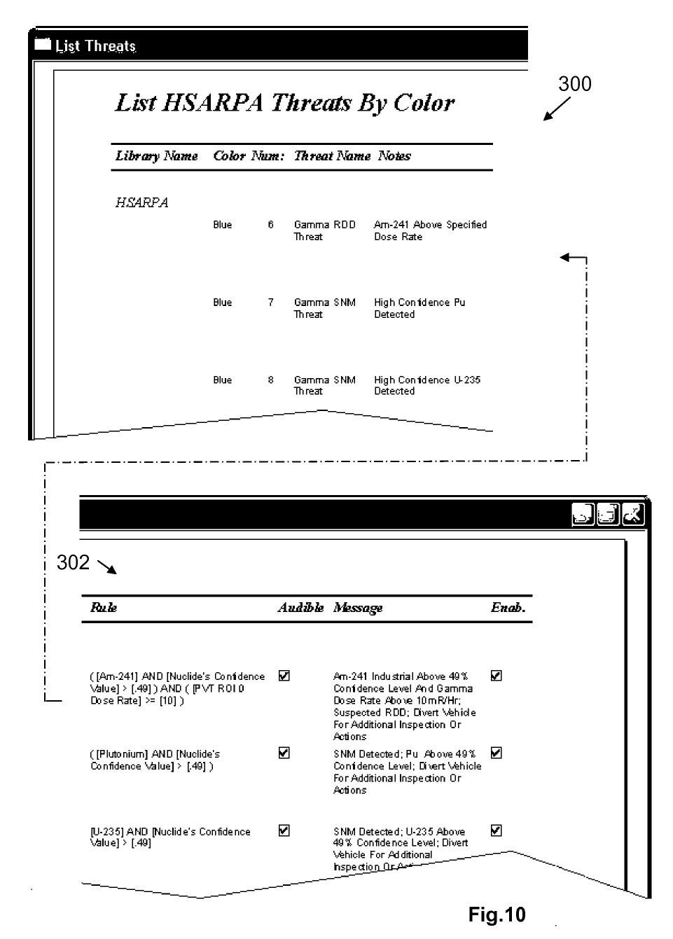

Clicking on the Show Report On Threat Rules By Color For HSARPA 160 button of the Main Menu 150 of FIG. 5 opens a window depicted in part in FIG. 10, listing the Rules in alphabetic color order. Shown in FIG. 10 are a left portion 300 and a right portion 302 of a print preview screen.

The Main Menu 150 of FIG. 5 also includes a Nuclide Library 162 button. Clicking on the Nuclide Library 162 button opens the Spectrum Library selection window 310 depicted in FIG. 11. Any Threat Matrix Rules developed by a user are tied to a nuclide library and a rule set name and version number. The user may choose the nuclide library to be used with the Threat Matrix. Clicking on a nuclide library that is different from the highlighted menu selection places the newly selected library in the header banner 312. Clicking on the Close Form 314 button exits the window, and the software determines if the library has been changed. If a new nuclide library has been selected, the software will process the change and begin using the newly selected library with the Threat Matrix as depicted in the For Spectrum Library field 248 and the Threat Input box 252 of FIG. 7. Depending on the size of the nuclide library chosen, it may take some time for the software to process the change. Once the library has been processed, the Main Menu 150 of FIG. 5 will reappear. If a nuclide library is not used, then spectroscopy is not available in the system 10 and the user will be able to create a rule set by name and version number. In the Main Menu 150 the rule set name and version is displayed.

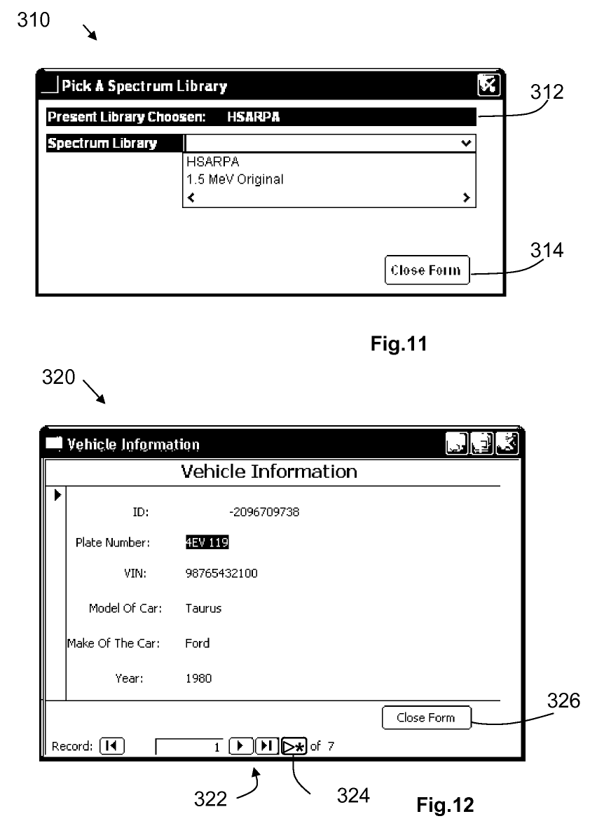

Clicking on the Vehicle Library 164 button of the Main Menu 150 of FIG. 5 opens the Vehicle Information window 320 depicted in FIG. 12. This window allows the user to change information about vehicle license plates, make and model, etc. The user may modify the vehicle database file by adding, editing, or deleting records. Records may be selected by clicking on the arrows 322 at the bottom of the Vehicle Information window 320. Records may be added by clicking on the right arrow with the * 324 at the bottom of the window. A new (empty) record will be displayed. The ID field is automatically filled by the software, and the user may use the Tab key to move to the remaining fields and enter information. Once the information has been entered, the user may open another new record or close the form by clicking on the Close Form 326 button.

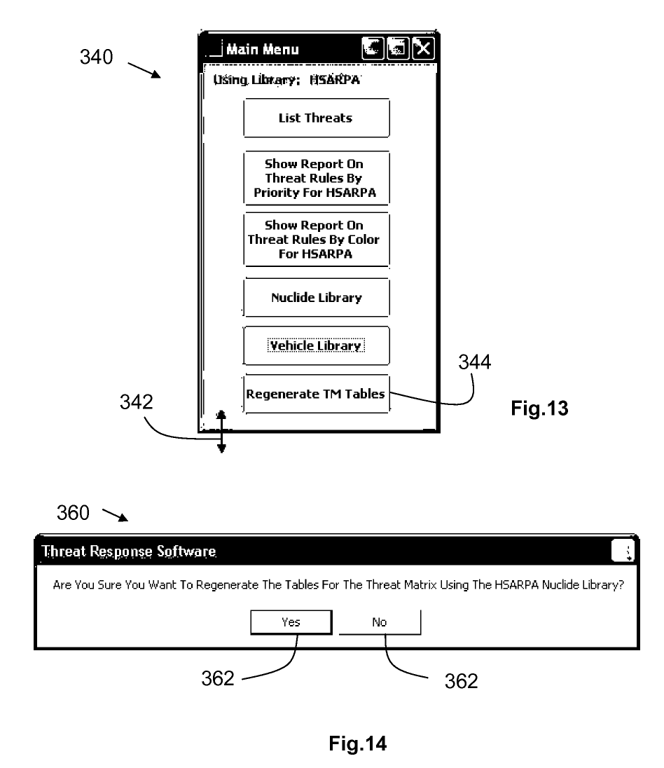

If the user makes changes to any information in any database form while running the user interface, the underlying tables should be regenerated before the user makes additional edits to another table. In any event, these internal tables must be regenerated so the updated information can be used by the software. In order to regenerate the internal tables used by Threat Matrix software, the user must create an expanded Main Menu 340 as depicted in FIG. 13. To do this, the Main Menu 150 of FIG. 5 is selected by clicking on the title bar 152. Once selected, the menu may be expanded by moving the cursor to the bottom border (342 of FIG. 13) of the menu, clicking and holding the left mouse button down, and dragging the mouse down. The cursor will change to a line with arrows on each end when it is in the proper position to expand the menu. Once the main menu is expanded, the Regenerate TM Tables 344 button is visible.

Clicking on the Regenerate TM Tables 344 button opens a window 360 in FIG. 14 which asks the user to confirm that the tables are to be regenerated. The user then confirms the intent by pressing the Yes 362 or No 362 button. Once the user confirms that the tables are to be regenerated, it may take some time for the software to complete the task. The user will know when the software has completed regenerating the tables when all the buttons on the Main Menu 150 of FIG. 5 (or expanded Main Menu 340 of FIG. 13) are enabled again. (The software disables all the buttons while it is regenerating the tables.)

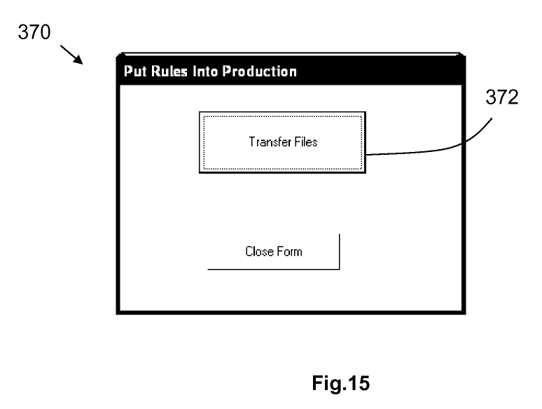

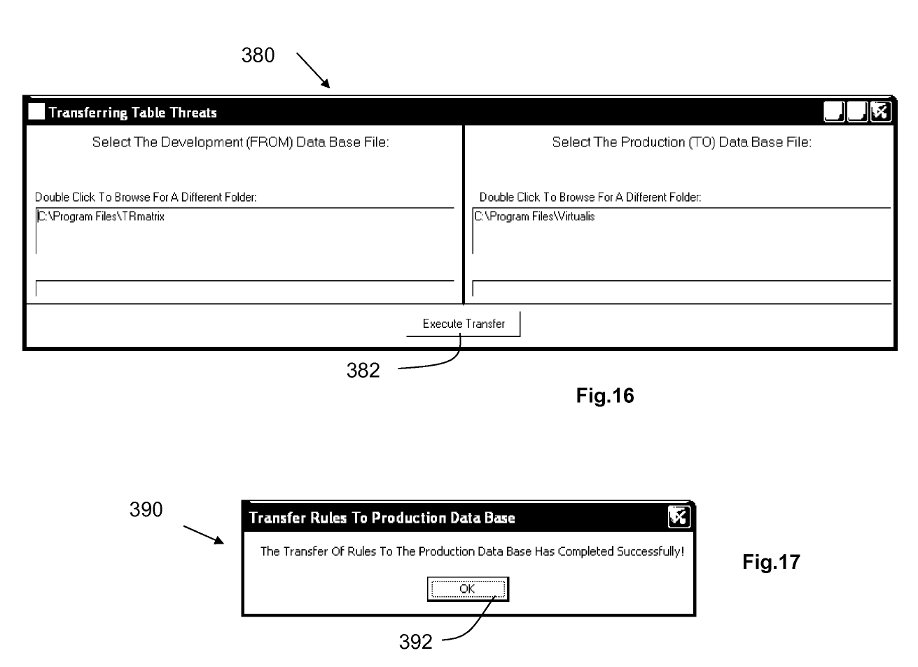

If information has been added or changed in any of the Threat Matrix Rules, another software application must be run to transfer the development Threat Matrix tables into the production Threat Matrix database or optionally to a binary file. To open this application, the user typically double-clicks an icon on the desktop of the personal computer or workstation. The binary compiler software opens and the window 370 shown in FIG. 15 is displayed. Clicking on the Transfer Files 372 button initiates the transfer of the tables. The user is given the opportunity to select the specific development and production databases to transfer with the window 380 depicted in FIG. 16. When that information is properly established, the user presses the Execute Transfer button 382. While the software is performing the transfer a message screen will appear asking the user to wait. Once the transfer is complete, the screen 390 of FIG. 17 is presented to the user. The user acknowledges this by pressing the OK 392 button. The Rules files are then available for use by the Execution Engine.

The foregoing descriptions of embodiments of this invention have been presented for purposes of illustration and exposition. They are not intended to be exhaustive or to limit the invention to the precise forms disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A system for evaluating a physical phenomenon, the system comprising:
a data file defining a plurality of mathematical expressions, each mathematical expression incorporating at least one physical variable that at least in part establishes a computational result for the mathematical expression when the mathematical expression is evaluated, and each mathematical expression having an associated threshold criterion and having an associated actionable output to be initiated if the mathematical expression evaluates to the threshold criterion;
a data acquisition system configured for providing a measurement of a physical parameter corresponding to the at least one physical variable;
an execution engine configured for reading the plurality of mathematical expressions from the data file and configured for acquiring the measurement of a physical parameter corresponding to the at least one physical variable and configured for evaluating each mathematical expression by substituting each measurement of the physical parameter for the corresponding at least one physical variable and configured for initiating the associated actionable output if the computational result of the mathematical expression evaluates to the threshold criterion.

2. The system of claim 1 wherein the plurality of mathematical expressions is defined in priority order in the data file and the execution engine is configured for sequentially reading the plurality of mathematical expressions in priority order.

3. The system of claim 1 wherein the mathematical expressions comprise at least one Boolean expression wherein the computational result is a TRUE/FALSE logic state and the threshold criterion is an actionable logical state.

4. The system of claim 3 wherein the at least one Boolean expression incorporates a physical variable that is a pseudo physical variable that comprises a subordinate Boolean expression that incorporates the at least one physical variable.

5. The system of claim 1 wherein the data file is a compiled binary file.

6. The system of claim 1 wherein:
the data file defines a plurality of selected mathematical expressions;
the execution engine is configured for sequentially reading the plurality of selected mathematical expressions from the data file and configured for evaluating each selected mathematical expression by directly substituting each measurement of the physical parameter for the corresponding at least one physical variable and configured for initiating the associated actionable output if the computational result of the selected mathematical expression evaluates to the threshold criterion.

7. The system of claim 1 wherein at least one mathematical expression includes expert knowledge.

8. A system for evaluating a physical phenomenon, the system comprising:
a data file defining a Boolean expression incorporating a physical variable that at least in part establishes a logical TRUE/FALSE state of the Boolean expression, and the Boolean expression having an associated actionable output to be initiated if the Boolean expression evaluates to an actionable logical state;
a data acquisition system for providing a measurement of a physical parameter corresponding to the physical variable;
an execution engine configured for reading the Boolean expression from the data file and configured for acquiring the measurement of the physical parameter and configured for evaluating the Boolean expression by substituting the measurement of the physical parameter for the physical variable and configured for initiating the actionable output if the logical TRUE/FALSE state of the Boolean expression evaluates to the actionable logical state.

9. The system of claim 8 where in the physical variable is a radiation level and measurement of a physical parameter is a radiation measurement.

10. The system of claim 8 wherein the Boolean expression incorporates a pseudo physical variable that comprises a subordinate Boolean expression that incorporates the physical variable.

11. The system of claim 8 wherein:
the Boolean expression incorporates a plurality of physical variables;
the data acquisition system provides a plurality of measurements of one or more physical parameters, each measurement corresponding to at least one of the physical variables; and
the execution engine directly substitutes each measurement of the one or more physical parameters for the corresponding at least one of the physical variables.

12. The system of claim 8 wherein the data file is a compiled binary file.

13. The system of claim 8 wherein the mathematical expression includes expert knowledge.

14. A method of evaluating a physical phenomenon, the method comprising:
(a) creating a prioritized set of rules, wherein each rule incorporates at least one physical variable that at least in part establishes a computational result for the rule when the rule is evaluated in view of a measurement of a physical parameter associated with the at least one physical variable;
(b) for each rule in the set of rules, defining a threshold criterion and defining an associated actionable output if the computational result of the rule evaluates to the threshold criterion;
(c) measuring the physical parameter corresponding to the at least one physical variable in each rule;
(d) evaluating each rule by substituting the measurement of the physical parameter corresponding to the at least one physical variable in the rule being evaluated and initiating the actionable output associated with the rule being evaluated if the computational result of the rule being evaluated evaluates to the threshold criterion associated with the rule being evaluated.

15. The method of claim 14 wherein step (a) comprises creating a prioritized set of rules, wherein one or more of the rules incorporate a plurality of physical variables that at least in part establish a computational result for the rule when the rule is evaluated in view of a measurement of the physical parameter associated with the at least one physical variable.

16. The method of claim 14 wherein at least one rule comprises a mathematical expression.

17. The method of claim 14 where at least one rule comprises a Boolean expression.

18. The method of claim 14 further comprising selecting a subset of the set of rules for evaluation; and wherein:
step (c) comprises measuring a physical parameter corresponding to the at least one physical variable in each rule in the selected subset of the set of rules; and
step (d) comprises evaluating each rule in the selected subset of the set of rules by directly substituting the measurement of the physical parameter corresponding to the at least one physical variable in the rule being evaluated and initiating the actionable output with the rule being evaluated if the computational result of the rule being evaluated evaluates to the threshold criterion associated with the rule being evaluated.

19. The method of claim 14 further comprising,
step (b-1): selecting for evaluation a subset of the physical variables that at least in part establishes a computational result for at least one rule when the at least one rule is evaluated, and
step (b-2): selecting for evaluation a subset of the set of rules, the subset of the set of rules including each rule in the set of rules that incorporates physical variables corresponding only to physical variables in the subset of physical variables;
and wherein step (c) comprises measuring a physical parameter corresponding to the at least one physical variable in each rule in the subset of the set of rules; and
step (d) comprises evaluating each rule in the subset of the set of rules by directly substituting the measurement of the physical parameter corresponding to each at least one physical variable in the rule being evaluated and initiating the associated actionable output if the computational result of each selected mathematical expression evaluates to the threshold criterion associated with the rule being evaluated.

20. The method of claim 14 further comprising,
step (b-1) verifying availability of the measurement of a physical parameter corresponding to the at least one physical variable; and
step (b-2) initiating an actionable output if the measurement of the physical parameter corresponding to the at least one physical variable is not available.
